(19) United States
(12) Patent Application Publication
(10) Pub. No.: US 2025/0350194 A1
(43) Pub. Date: Nov. 13, 2025

(54) SYSTEM AND METHODS FOR DIGITAL CONTROL OF TOTEM POLE POWER FACTOR CORRECTION CIRCUITS IN CRITICAL CONDUCTION MODE

(71) Applicant: Navitas Semiconductor Limited, Dublin (IE)

(72) Inventors: Xuefeng FAN, Hangzhou (CN); Tao WEI, Hangzhou (CN); Wenhao YU, Hangzhou (CN); Yingchun XU, Hangzhou (CN)

(73) Assignee: Navitas Semiconductor Limited, Dublin (IE)

(21) Appl. No.: 19/200,595

(22) Filed: May 6, 2025

(30) Foreign Application Priority Data
May 8, 2024 (CN) 202410564519.6

(51) Int. Cl. H02M 1/42; H02M 1/00

(52) U.S. Cl. CPC H02M 1/4208; H02M 1/0009; H02M 1/0043

(57) ABSTRACT

A CrM totem pole PFC digital control method. In one aspect, the method includes mixed use of control of voltage outer loop and average current inner loop to improve dynamic performance and achieve current sharing performance. In another aspect, a PFC circuit includes a first switch coupled to a second switch, an inductor coupled between a switch node and an AC input terminal, and a control circuit arranged to: detect an input voltage at the AC input terminal; detect a current in the inductor and generate a signal corresponding to an average of the current; detect an output voltage of the PFC circuit at an output terminal; generate a reference current based on the detected output voltage and the detected input voltage and control a first on-time of the first switch and a second on-time of the second switch based on comparison of the signal to the reference current.

### CROSS REFERENCE TO RELATED APPLICATIONS

This application claims priority to Chinese provisional patent application no. 202410564519.6, for “CRM TOTEM POLE PFC DIGITAL CONTROL METHOD” filed on May 8, 2024, which is hereby incorporated by reference in entirety for all purposes.

### FIELD

The described embodiments relate generally to power converters, and more particularly, the present embodiments relate to system and methods for digital control of totem pole power factor correction (PFC) circuits.

### BACKGROUND

Electronic devices such as computers, servers and televisions, among others, employ one or more electrical power conversion circuits to convert one form of electrical energy to another. Power conversion system efficiency is becoming ever more important due to economic reasons and environmental concerns. Some electrical power conversion circuits convert an AC voltage to a DC voltage using a circuit topology called totem pole power factor correction (PFC) circuit. The totem pole PFC circuit may operate in critical conduction mode (CrM).

The CrM totem pole PFC topology may use a relatively small inductor by operating at relatively high frequencies and can be generally used in high-efficiency and high-power density power supply applications. In present approaches, there can be two control methods for the control of the totem pole PFC operating in the CrM mode: voltage mode control and current mode control.

In the voltage mode control, when an RMS value of the input voltage and the output power are constant, the on-time of the high-frequency switch may be a constant value, and no current loop control may be used. The input current can follow the sinusoidal waveform of the input voltage. The voltage mode can be relatively simple to use and may use relatively small amount of calculation. For single-phase PFC, this control method can generate relatively good performance characteristics, such as a stable output voltage, and well-balanced power factor and total harmonic distortion (THD) characteristics.

For multi-phase PFC, the voltage mode control method may create an issue regarding uneven phase currents. This may be due to the fact that each phase may have its own operating frequency that can vary, where the operating frequency of each phase may not be 180° out of phase with each other. Thus, relatively large ripple may be generated in multi-phase voltage mode controlled system, which may require filtering that can increase the system costs substantially. Furthermore, each phase may use components that may have relatively precise values in order to minimize system ripple. Thus, each phase' inductance tolerances may have relatively high precision in order to reduce system ripple. As the operational frequencies have increased, this issue may be more challenging due to the relatively smaller value and size of the inductor, causing an uneven current problem caused by inconsistent inductance values, thus the disadvantages of the voltage mode control method can be more noticeable as operating frequency increase.

In the current mode control method, the system may calculate and adjust a peak value of the inductor current to determine an appropriate turn-on and turn-off of the high-frequency switch, thereby addressing the problem of uneven current in the voltage mode control method. However, the current mode control method may have an issue of noise when sampling the switch current. Moreover, the current mode control method may have a relatively slow dynamic response. Further, the above-described control methods used in present approaches may be based on control of a single voltage loop, causing a relatively low performance of the input and output dynamic characteristics.

### SUMMARY

In some embodiments, a power factor correction (PFC) circuit is disclosed. The circuit includes a first switch coupled to a second switch at a switch node; an inductor coupled between the switch node and an AC input terminal; a control circuit arranged to: detect an input voltage at the AC input terminal; detect a current in the inductor and generate a signal corresponding to an average of the current; detect an output voltage of the PFC circuit at an output terminal; generate a reference current based on the detected output voltage and the detected input voltage; and control a first on-time of the first switch and a second on-time of the second switch based on a comparison of the signal to the reference current.

In some embodiments, the PFC circuit is arranged to operate in critical conduction mode (CrM).

In some embodiments, the control circuit is further arranged to generate a feedforward coefficient based on the reference current and the input voltage.

In some embodiments, the control circuit is further arranged to control the first on-time of the first switch and the second on-time of the second switch based additionally on the feedforward coefficient.

In some embodiments, the control circuit is further arranged to generate a first off-time of the first switch when the current in the inductor reaches zero or negative.

In some embodiments, the switch node is a first switch node, the inductor is a first inductor, and the first inductor is coupled between the first switch node and the AC input terminal, where the PFC circuit further includes a third switch coupled to a fourth switch at a second switch node, a second inductor coupled between the second switch node and the AC input terminal.

In some embodiments, the combination of the first switch, the second switch, and the first inductor, and the combination of the third switch, the fourth switch, and the second inductor are arranged to operate in an interleaved mode with a phase delay of 180°.

In some embodiments, the first switch and the second switch are gallium nitride (GaN)-based.

In some embodiments, the PFC circuit is a totem pole PFC circuit.

In some embodiments, the control circuit is further arranged to generate a second off-time of the second switch when the current in the second inductor reaches zero.

In some embodiments, a method of operating a power factor correction (PFC) circuit is disclosed. The method includes providing a first switch coupled to a second switch at a switch node; providing an inductor coupled between the switch node and an AC input terminal; detecting an input voltage at the AC input terminal; detecting a current in the inductor and generate a signal corresponding to an average of the current; detecting an output voltage of the PFC circuit at an output terminal; generating a reference current based on the detected output voltage and the detected input voltage; and controlling a first on-time of the first switch and a second on-time of the second switch based on a comparison of the signal to the reference current.

In some embodiments, the method further includes generating a feedforward coefficient based on the reference current and the input voltage.

In some embodiments, the method further includes controlling the first on-time of the first switch and the second on-time of the second switch based additionally on the feedforward coefficient.

In some embodiments, the method further includes generating a first off-time of the first switch when the current in the inductor reaches zero.

In some embodiments, the method further includes generating a second off-time of the second switch when the current in the second inductor reaches zero.

In some embodiments, a method of operating a multi-phase critical conduction mode totem pole power factor correction (PFC) circuit is disclosed. The method include: providing a first phase having a first switch coupled to a second switch at a first switch node; providing a second phase having a third switch coupled to a fourth switch at a second switch node; providing a first inductor coupled between the first switch node and an AC input terminal; providing a second inductor coupled between the second switch node and the AC input terminal; detecting a current in the first inductor and generate a signal corresponding to an average of the current; detecting a first switching period of the first phase and a second switching period of second phase; detecting a phase error between the first switching period and the second switching period; generating a reference current based on a sampled value of the phase error and a reference value of phase error; and controlling an on-time of third and fourth switches based at least on a comparison of the signal to the reference current.

### BRIEF DESCRIPTION OF THE DRAWINGS

FIG. 1 shows a schematic of a two-phase CrM totem pole PFC circuit, according to some embodiments of the disclosure;

FIG. 2 shows a schematic of a single phase CrM totem pole PFC, according to some embodiments;

FIG. 3 shows the operating waveforms of the single phase CrM totem pole PFC of FIG. 2;

FIG. 4 illustrates a CrM totem pole PFC converter using a control circuit, according to some embodiments;

FIG. 5 shows the operating waveforms of an exemplary modification coupon;

FIG. 6 shows the operating waveforms of the exemplary modification coupon under dynamic switching of AC voltage from 180 VAC to 264 VAC;

FIG. 7 illustrates a flowchart of an exemplary method for determining on-time of the PFC switches, according to some embodiments of the disclosure;

FIG. 8 illustrates a flowchart of an exemplary method for determining on-time of the PFC switches based additionally on a feedforward coefficient, according to some embodiments of the disclosure; and

FIG. 9 illustrates a flowchart of an exemplary method for determining charging time of the PFC inductor in each switching cycle, according to some embodiments of the disclosure.

### DETAILED DESCRIPTION OF THE INVENTION

Circuits, structures, and related techniques disclosed herein relate generally to power converters. More specifically, circuits, devices and related techniques disclosed herein relate to system and methods for digital control of totem pole power factor correction (PFC) circuits. In some embodiments, digital control methods for totem pole PFC circuits operating in critical conduction mode (CrM) are disclosed. In various embodiments, a hybrid voltage-current mode dual closed-loop method for operating multi-phase totem pole PFC circuit in CrM mode is disclosed. The control methods for operating multi-phase totem pole PFC circuit in CrM mode may use average inductor current to determine the on-time of the PFC switch. Circuits and techniques disclosed herein can use sampling of the input and output voltages, and use the average inductor current to determine on-time of the main switch. In some embodiments, the results of the samplings can be digitally filtered and used in the control method calculations.

In some embodiments, a method controlling a totem pole PFC operating in CrM can include a main control loop having two parts: a voltage outer loop and a relatively fast current inner loop. An instantaneous current in the PFC inductor may be sampled, and a corresponding average inductor current can be sampled by a micro-controller (MCU). Further, a reference current may be generated based on an output of the outer voltage loop, a real-time value of AC input voltage, and an effective value of the input voltage. The average current can be compared to the reference current to determine an on-time of the PFC main switch for each switching cycle. In this way, the output voltage can be stabilized corresponding to the reference value, enabling the system to control the input current to follow the input voltage, and enabling operation with a relatively high power factor.

In various embodiments, a controller circuit is disclosed that is arranged to implement control methods for controlling totem pole PFC circuits operating in CrM mode. The control circuit may include a digital signal processor (DSP) and/or a micro-controller (MCU) that are arranged to perform calculations to determine an on-time of the PFC main switch based on the results of the current inner loop and of the voltage outer loop. Techniques disclosed herein enable use of average inductor current information to determine an on-time of the main switch, thereby enabling mitigation of current sharing issues that may be caused by each phase of the multi-phase PFC circuit using components having different values, such as dissimilar values of the inductor in each phase. Thereby, disclosed techniques can enable relatively high operating frequencies in multi-phase CrM totem pole PFC circuits with relatively low ripple.

In some embodiments, a feedforward technique may be used to accelerate dynamic response to changes in the input voltage, such that the duty cycle can be adjusted relatively rapidly. In this way, ripple on the output voltage can be reduced. In various embodiments, a feedforward coefficient may be determined by the current loop and used to obtain the on-time of the PFC switch. By using a feedforward coefficient, dynamic response of the system can be improved. In various embodiments, an on-time of the main switch in the steady state can be calculated in advance and provided as a feedforward coefficient. The feedforward coefficient can be generated based on an input voltage and an average inductor current, and can be

$${T}_{feed} = k \frac{2 {L}_{f} \cdot {i}_{ref}}{{v}_{i n}}$$

where a weight coefficient k can be added to adjust the effect of the feedforward (when k=0, the feedforward control function is not used) to meet the various operational conditions of various parameters (e.g., input voltage, power), thereby further optimizing the control methods.

Techniques and circuits disclosed herein enable combination of the feedforward techniques and the output of the current inner loop to determine an on-time of the PFC main switch, and to determine an energy storage time of the boost inductor. In some embodiments, a shutdown of the synchronous rectifier switch can be detected in a variety of ways, including, but not limited to, using the inductor current zero-crossing detection (ZCD) signal, negative current detection, and/or theoretical calculations. The calculated on-time can be converted into a numerical value and assigned to a timer module (TIMER) in the controller circuit to generate a corresponding pulse width modulated (PWM) signal. In various embodiments, the turn-on time and turn-off time of the line frequency switch can be related to the positive and negative polarities of the input voltage.

In some embodiments, to address the continuous variation in switching frequencies during the line cycle for CrM totem pole PFC, a phase closed loop control can be added to achieve a well-functioning dynamic master/slave phase under target interleaving phase error operating conditions. In some embodiments, disclosed phase control method may be used to capture master phase' switching period and phase error respectively. Inputs of the control loop may include master phase' switching period, phase error and reference value of phase error, then generate an output Δi_{ref} that can be applied to reference current i_{ref} of slave phase. The phase error may be controlled dynamically by adjusting the on-time of switches. In various embodiments, a full range soft switching can be implemented enabling the disclosed CrM totem pole PFC digital control methods to adjust an on-time of the PFC main switch in relatively rapidly for conditions when the input and/or output voltages are changing rapidly. In various embodiments, disclosed methods can improve current sharing for multi-phase PFC circuits since the current loop of each phase may share the same reference value. In this way, embodiments of the disclosure can address the issue of variation in the value of the inductor used in multi-phase CrM totem pole PFC circuits.

In some embodiments, the main switches and/or line switches used in the totem pole PFC circuit can be gallium nitride (GaN) based, thus enabling relatively high operational frequencies. In various embodiments, the switches can be silicon or silicon carbide (SiC) based switches. In some embodiments, the switches can be MOSFETS and/or IGBT switches. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

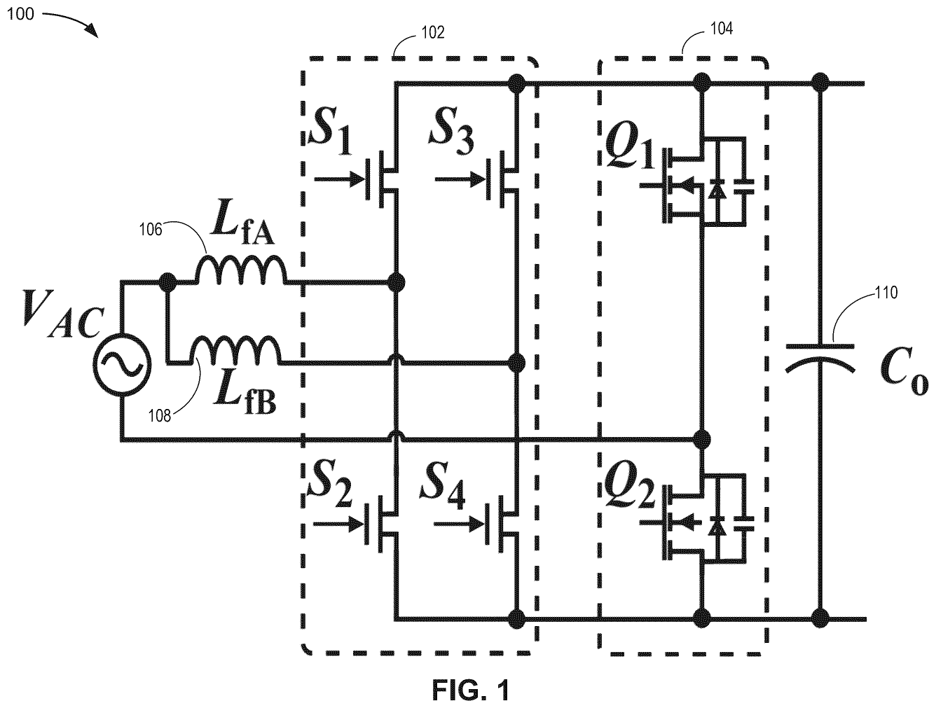

FIG. 1 shows a schematic of a two-phase CrM totem pole PFC circuit, according to some embodiments of the disclosure. In the illustrated embodiment, a PFC circuit 100 may include a high-frequency bridge 102, a line frequency bridge 104, first boost inductor 106 and second boost inductor 108, and an output filter capacitor 110. In the illustrated embodiment, the high-frequency bridge 102 is shown having two phases using a first boost inductor 106 and the second boost inductor 108. In some embodiments, the high-frequency bridge 102 may be single-phase circuit using a single boost inductor. In various embodiments, the number of phases in the high-frequency bridge can be three or more. In some embodiments, the high-frequency bridge 102 may use silicon-based Metal-Oxide-Semiconductor Field-Effect Transistor (MOSFET) switches, or gallium nitride (GaN) based switches, or silicon carbide (SiC) based switches.

The high-frequency bridge 102 may have two phases that include switches S1, S2, S3 and S4. These switches may also be referred to as main switches. S1 and S2 can form a first phase and S3 and S4 can form a second phase. In some embodiments, switches S1, S2, S3 and S4 can be silicon-based MOSFET, or GaN-based switches, or silicon carbide-based switches. The line frequency bridge 104 may include switches Q1 and Q2. In some embodiments, switches Q1 and Q2 can be silicon-based MOSFET, or GaN-based or silicon carbide-based switches. In some embodiments, Q1 and Q2 may be replaced by diodes.

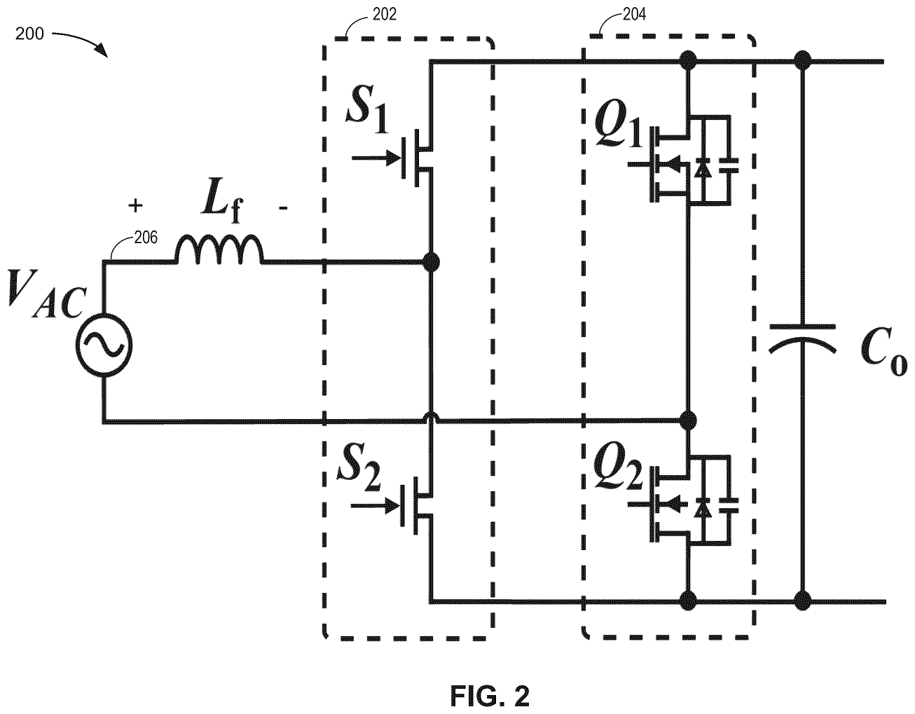

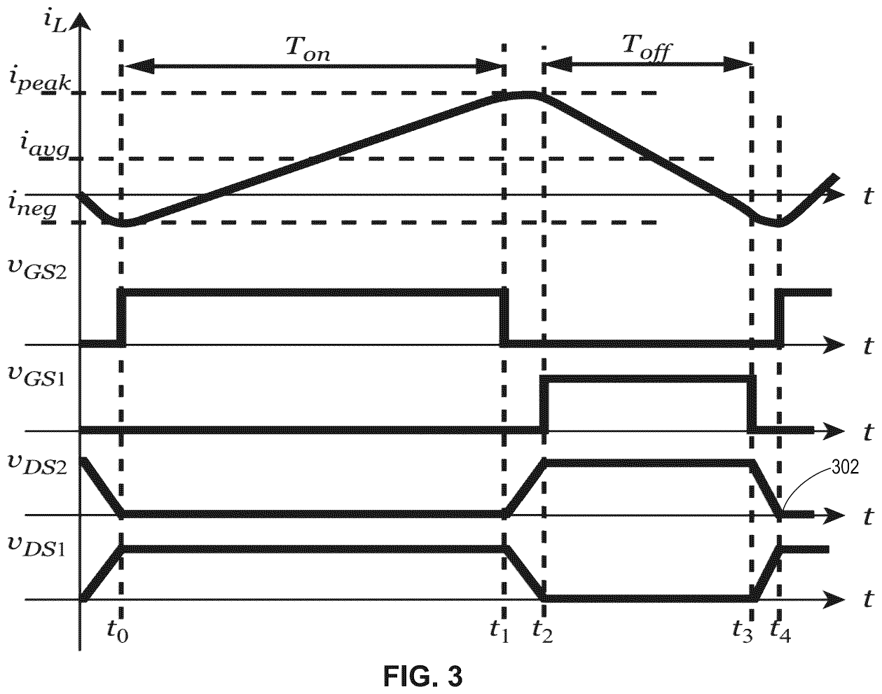

FIG. 2 shows a schematic of a single phase CrM totem pole PFC, according to some embodiments. FIG. 3 shows the operating waveforms of the single phase CrM totem pole PFC of FIG. 2. As shown in FIG. 2, the single phase CrM totem pole PFC circuit 200 may include a PFC boost inductor L_{f}, output filter capacitor Cₒ, high-frequency bridge 202 having switches S₁ and S₂ and line frequency bridge 204 having switches Q₁ and Q₂. An input terminal 206 can be coupled to an input voltage V_{AC}. When the input voltage is positive, S₂ can be the active switch, and S₁ can be the synchronous rectifier switch. When the input voltage is negative, S₁ can be the active switch, and S₂ can be the synchronous rectifier switch.

When the switching cycle is in the positive half cycle, the line frequency switch Q₂ is turned on, Q₁ is turned off, and S₂ can be the main switch, S₁ can be the synchronous rectifier. When the switching cycle is in the negative half cycle, the line frequency switch Q₁ is turned on, and Q₂ is turned off, and S₁ is the main switch and S₂ is the synchronous rectifier switch. In the positive half cycle, the operating waveforms of the single phase CrM totem pole PFC circuit 200 in a single switching cycle are shown in FIG. 3. During the positive half cycle, switch Q₂ can be on, and the line frequency switch Q₁ can be off. The positive direction of the inductor current is defined as flowing from the grid side to the midpoint of the high-frequency bridge 202.

Referring to FIG. 3, at time to, the switch S₂ starts to be turned on. The inductor L_{f} is subjected to a forward voltage drop V_{AC} across two ends, and the inductor stores energy. During this time, the inductor current rises linearly until the time t₁ when the switch S₂ is turned off and the inductor current reaches its peak value. During the time t₁ to t₂, the switches S₁ and S₂ are both in the off state. The parasitic capacitance of the switch S₁ is connected with the parasitic capacitance of the switch S₂ in parallel and may resonates in series with the inductor L_{f}. The parasitic capacitance of switch S₂ is charged, and at the same time, the parasitic capacitance of the switch S₁ may be discharged. Meanwhile, v_{DS2} (drain-to-source voltage of S₂) rises and v_{DS1} (drain-to-source voltage of S₁) falls. Until t₂ is reached, v_{DS2} rises to the output voltage value, and v_{DS1} drops to zero.

At time t₂, the synchronous rectifier switch S₁ is turned on, and the inductor current continues to flow through the channel of the switch S₁. At this time, switch S₁ can be turned on with zero voltage. The voltage across two ends of the inductor is V_{AC}-Vₒ. The inductor transfers energy to the load, and the inductor current begins to decrease linearly until the switch S₁ is turned off at time t₃. After switch S₁ is turned off at time t₃, the parasitic capacitances of the switches S₁ and S₂ are connected in parallel and may resonate with the inductor's inductance. At this time, the direction of the inductor current is negative, and it charges the parasitic capacitor of S₁ and discharges the parasitic capacitor of S₂, with v_{DS2} decreasing and v_{DS1} increasing. By controlling the on-time of the switch S₁, the resonance of v_{DS2} can be reduced to zero. Until time t₄ is reached, the switch S₂ can be turned on with zero voltage.

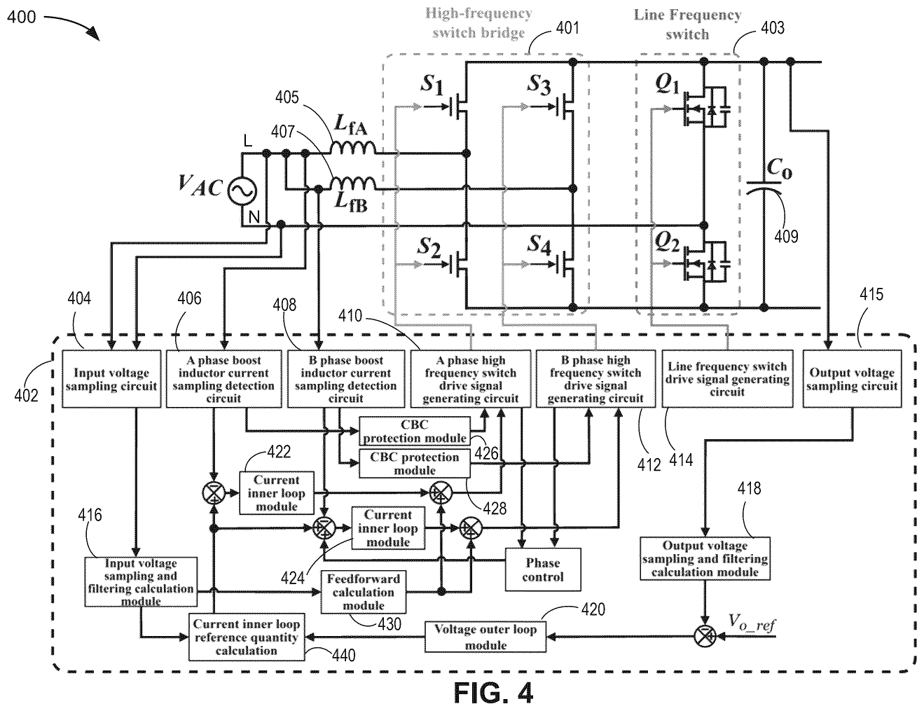

FIG. 4 illustrates a CrM totem pole PFC converter using a control circuit, according to some embodiments. As shown in FIG. 4, a PFC converter 400 may include a controller circuit 402 arranged to control the PFC converter using a digital control method. The digital control method can include a hybrid voltage-current dual closed-loop method. The disclosed digital control method can be used for a single-phase or multi-phase CrM totem pole PFC converter circuits. As shown in the FIG. 4, the totem pole PFC converter 400 can include a high-frequency bridge 401, a line frequency bridge 403, boost inductors 405 and 407, and an output capacitor 409. The control circuit 402 can include an input voltage L-line and N-line sampling circuit 404, a first and second boost inductor current sampling detection circuits 406 and 408, an output voltage sampling circuit 415, a first and second high frequency switch drive signal generating circuits 410 and 412, and a line frequency switch drive signal generating circuit 414. Each of the first and second boost inductor current sampling detection circuits may include a sampling of the average value and real-time value of the inductor current in each phase, which is used for the calculation of the current inner loop module, the inductor current cycle-by-cycle (CBC) protection circuit, and the control of the shutdown of the synchronous rectifier switch.

In some embodiments, a CrM totem pole power factor correction (PFC) circuit may include a first switch coupled to a second switch at a switch node, an inductor coupled between the switch node and an AC input terminal, and a control circuit arranged to: detect an input voltage at the AC input terminal; detect a current in the inductor and generate a signal corresponding to an average of the current; detect an output voltage of the PFC circuit at an output terminal; generate a reference current based on the detected output voltage and the detected input voltage; and control a first on-time of the first switch and a second on-time of the second switch based on a comparison of the signal to the reference current.

In addition, the control circuit 402 may further include a micro-controller unit or a digital signal processing circuit (MCU/DSP) that can include an input voltage sampling and filtering calculation module 416, an output voltage sampling and filtering calculation module 418, a voltage outer loop calculation module 420, a first and second current inner loop modules 422 and 424, a first and second CBC protection modules 426 and 428, and a feedforward calculation module 430. In some embodiments, the control loop may include two parts: a relatively slow voltage outer loop calculation module and a relatively fast current inner loop calculation module. For the circuit outer loop, to prevent noise on the sampling circuit from interfering with the sampling results causing oscillation of the closed-loop results, the input line L and line N voltage samples and the output bus voltage can be filtered. The filtering may be implemented, among other filtering techniques, via software digital filtering. The filtered sampled values can then be passed to the voltage loop for calculation. The sampled value obtained from the input voltage filtering calculation module can be used to calculate an effective value of the input voltage, which may be used to determine the feedforward control, and to obtain a reference value of the current inner loop.

The voltage outer loop calculation module can compare the output voltage after digital filtering to a reference value and can perform calculation to generate a reference quantity after passing through the proportional integral (PI) loop. The voltage outer loop calculation module can also act on the current loop.

In some embodiments, the number of current loops in the control circuit 402 may be the same as the number of high-frequency bridges in the PFC converter 400. The control circuit 402 may include a current inner loop reference quantity calculation module 440. In various embodiments, the current inner loop reference quantity calculation module 440 can use three inputs to determine a reference value: 1) an output of the voltage outer loop module, which is used to stabilize the output voltage; 2) a real-time sinusoidal phase information of the input voltage, which controls the current to follow the input voltage; and 3) the effective value of the input voltage. The first and second current inner loop modules 422 and 424 can compare an average current obtained by the first and second boost inductor current sampling detection circuits 406 and 408, to the current loop reference value to determine the charging time of the PFC inductor in each switching cycle.

In some embodiments, dynamic performance and control effect can be enhanced by using a feedforward calculation module 430. The feedforward calculation module 430 may be added onto the disclosed control method. A pre-calculation of an open-loop theoretical on-time T_{feed} may be performed based on the input voltage and the average inductor current, and may be added to the control method as a feedforward factor, so as to further optimize total harmonic distortion (THD) and other performance characteristics. A feedforward superposition amount can be obtained as:

$${T}_{feed} = k \frac{2 {L}_{f} \cdot {i}_{ref}}{{v}_{i n}}$$

where L_{f} is the inductance of the first inductor and i_{ref} is the inductor current. A weight coefficient k may be added to adjust the effect of feedforward to meet the requirements of various operating conditions (e.g., input voltage, power, etc.). In this way, the control method can be further optimized. The result of the feedforward calculation module 430 may be added to the value obtained by the current inner loop in order to determine the final value Tₒₙ, i.e., the charging time of the boost inductor. In some embodiments, a maximum value of on-time Tₒₙ can be capped and limit the minimum operating frequency of CrM. The on-time Tₒₙ can be transmitted to a timer module (TIMER), where the TIMER can be a common module in MCU/DSP, that can be used to work with the circuits 410 and 412 to generate a corresponding PWM signal for the main switch(es), to control the switch(es) on-time. In some embodiments, the voltage outer loop calculation module 420 may not include a feedforward control. In various embodiments, the voltage loop, current loop, and feedforward coefficient may be used to determine the on-time of the main switch. In some embodiments, the addition of the feedforward control amount can be enabled or disabled based on test results (during manufacturing process). These methods are within the scope of this disclosure.

Referring again to FIG. 3, the inductor current waveform within one switching cycle is discussed now. After the current is calculated to obtain on-time Tₒₙ and the main switch has been turned on, the inductor current begins to increase linearly at the slope of V_{AC}/L_{f}. After a period of time Tₒₙ, the inductor current reaches a peak value of Iₚₑₐₖ and the main switch can be turned off. Then, the synchronous rectifier switch can be turned on, and the inductor current may decrease at a slope of

$$\frac{{V}_{o} - {V}_{A C}}{L} .$$

After the time of T_{off}, the inductor current may reach the minimum value I_{neg}. Subsequently, the controller circuit's current inner loop may determine Tₒₙ and the next cycle can start. In some embodiments, after the main switch is turned off the additional appropriate dead time can make the synchronous rectifier switch turn on with zero voltage across its drain-to source terminals (ZVS), such as illustrated at reference 302. In various embodiments, selecting a suitable T_{off} can operate the main switch with zero voltage (across its drain-to-source terminals) turn-on within each switching cycle. As appreciated by one of ordinary skill in the art having the benefit of this disclosure, there can be a variety of methods to turn off the synchronous rectifier, such as using the inductor current zero-crossing detection (ZCD) signal, negative current detection, or theoretical calculation T_{off}. The ZCD method may include use of an inductor auxiliary winding or a comparator to capture the ZCD signal. These methods of turning off the synchronous rectifier and their implementation can be used with the disclosed CrM totem pole PFC digital control methods. Further, the methods of turning off the synchronous rectifier and their implementation is within the scope of this disclosure.

In some embodiments, a closed loop to control phase error of master and slave phase dynamically can be added to mitigate current oscillation and hard switching that may exist in CrM totem pole PFC due to varying switching frequency. The control method can capture each phase's switching period and phase error. In various embodiments, sampled values and a reference of phase error may be obtained as the control loop's input. When there is a disturbance for master and slave phase, the close loop can detect an error between the master and slave phases, and then an output Δi_{ref} can be determined. This can modify the on-time of slave phase's high frequency switches. The switching frequency may be adjusted to achieve the balance of master-slave phase error, which can gradually converge in the closed loop control. Each phase may reach to a stable interleaving operating condition when the phase error converges to be zero.

In order to further illustrate disclosed control methods for controlling of a CrM totem pole PFC converter, the following is a description of an example modification coupon using the disclosed control methods. The modification coupon is an example of a GaN-based 3200 W two-phase interleaved CrM totem pole PFC converter. In this exemplary modification coupon, the inductor has a value of 40 μH and the output filter has a capacitance of 1000 μF. The exemplary modification coupon uses input voltage of 230V AC, input voltage frequency of 50 Hz, output voltage of 400 V, and an output power of 3200 W.

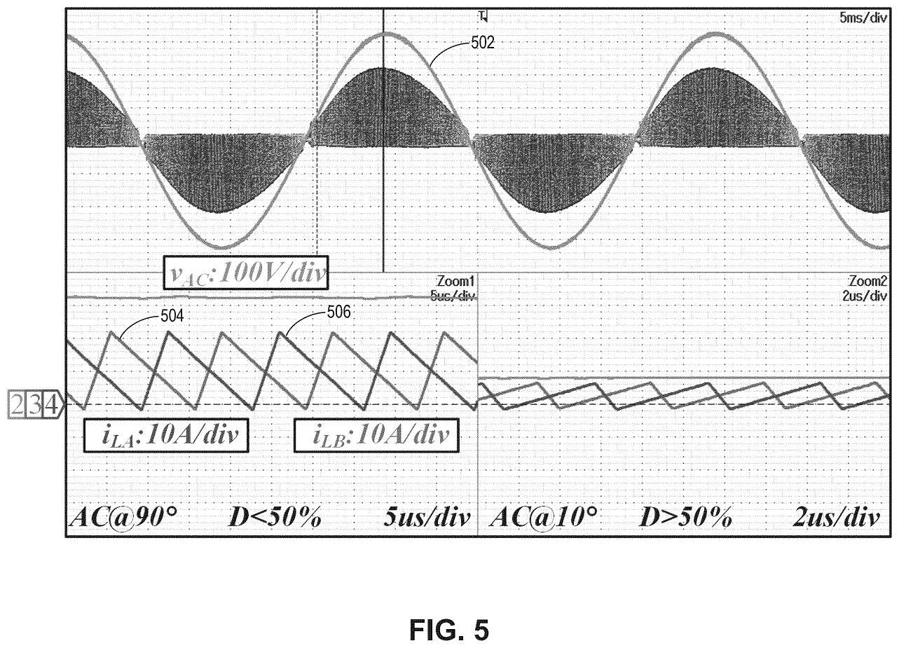

FIG. 5 shows the operating waveforms of the exemplary modification coupon. FIG. 5 shows input voltage and two-phase inductor current when operating at full load steady state at rated voltage. Graph 502 is the input voltage waveform, and graphs 504 and 506 are the respective two-phase inductor current waveforms. As can be seen in FIG. 5, disclosed control methods can control a single-phase or multi-phase PFC converter to stably operate in the CrM mode, thereby realizing the function of power factor correction. FIG. 5 shows waveforms when the converter operates under 230 Vac input and 400 Vdc output, the output power is 3200 W constant, stable operation means without the change of input voltage, output voltage and output power. Moreover, the disclosed control methods achieve current sharing with an error of less than 1% for the two-phase current, thereby achieving good current sharing performance. FIG. 5 also shows the locally-enlarged waveforms of the two-phase inductor current when the duty cycle is >50% and <50%. It can be seen that the disclosed CrM control methods can achieve 180° phase delay between the two interleaving phases under different voltages and duty cycles, as also explained in sections above.

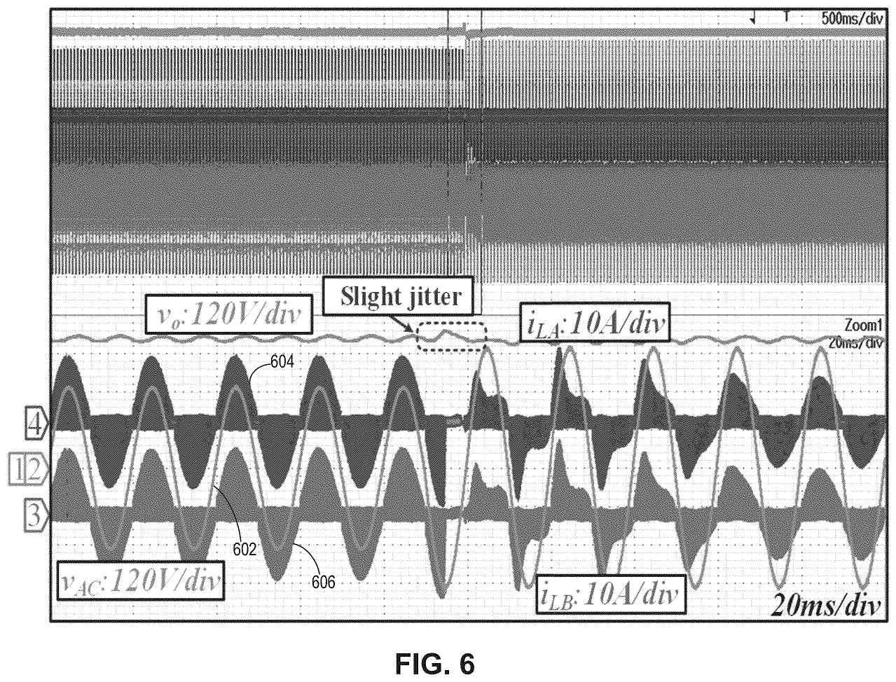

FIG. 6 shows the operating waveforms of the exemplary modification coupon under dynamic switching of AC voltage from 180 VAC to 264 VAC. Graph 602 is the input voltage waveform, and graphs 604 and 606 are the respective two-phase inductor current waveforms. The waveforms show that, when the input voltage is changing relatively rapidly, the high-bandwidth current loop can relatively rapidly adjust the on-time of the main switch within half an AC cycle, and achieve inductor current waveforms with non-sinusoidal envelopes in a short period of time, thereby accelerating the dynamic response and reducing the output voltage regulation rate.

Thus, it can be seen that the disclosed CrM totem pole PFC digital control method invention can be advantageous at least in the following ways: 1) The dual closed-loop control of voltage outer loop and current inner loop used can make single-phase or multi-phase PFC operate stably in the CrM mode and achieves soft switching in full range; 2) Use of an inner current loop, relatively good current sharing performance can be achieved for multi-phase PFC under different voltage and duty cycle conditions, thereby addressing the current balance problem of relatively different inductor values; and 3) the disclosed dual closed-loop control method can enable the on-time of the main switch to be adjusted relatively quickly under dynamic input voltage conditions, thereby improving dynamic response. Closed phase loop control for each phase is used to achieve stable interleaving for multi-phase PFC.

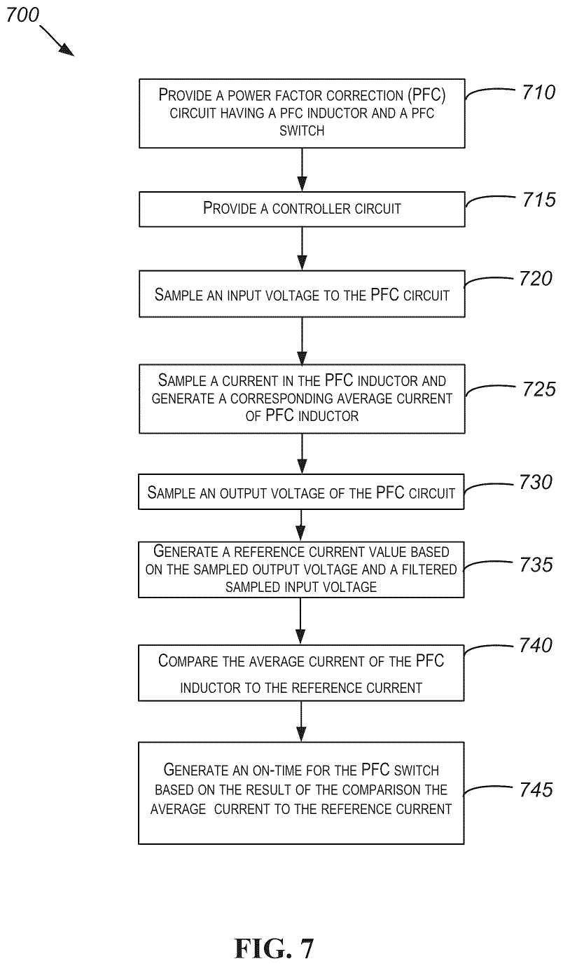

FIG. 7 illustrates a flowchart of an exemplary method 700 for determining on-time of a PFC switch, according to some embodiments of the disclosure. At block 710, a PFC circuit with a PFC inductor and a PFC switch is provided. At block 715, a controller circuit is provided. At block 720, the controller circuit can be arranged to sample an input voltage to the PFC circuit. At block 725, the controller circuit can be arranged to sample a current in the PFC inductor and generate a corresponding average current. At block 730, output voltage of the PFC circuit can be sampled. At block 735, a reference current can be generated based on the sampled output voltage and a filtered sampled input voltage. At block 740, the average current can be compared to the reference current. At block 745, on-time of the PFC switch can be generated based on the result of the comparison of the average current to the reference current. In some embodiments, the PFC circuit of block 710 may be a totem pole PFC circuit operating in CrM mode.

It should be appreciated that the specific steps illustrated in FIG. 7 provide a particular method of determining on-time of the PFC switch according to an embodiment of the disclosure. Other sequences of steps may also be performed according to alternative embodiments. For example, alternative embodiments of the disclosure may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

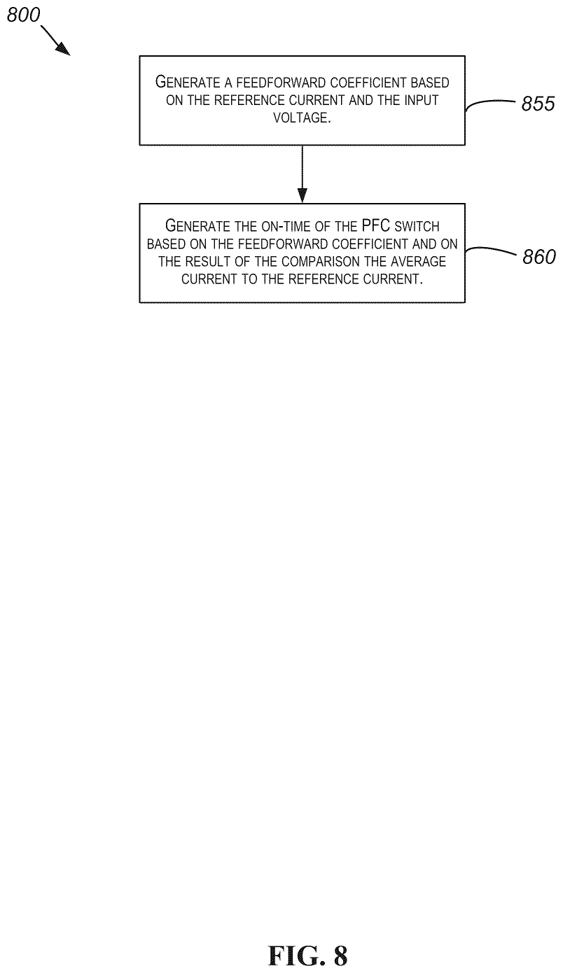

FIG. 8 illustrates a flowchart of an exemplary method 800 for determining on-time of the PFC switch based additionally on a feedforward coefficient, according to some embodiments of the disclosure. In block 855, a feedforward coefficient may be generated based on the reference current and the input voltage. In block 860, the on-time of the PFC switch may be generated based on the feedforward coefficient and the result of the comparison of the average current to the reference current.

It should be appreciated that the specific steps illustrated in FIG. 8 provide a particular method of determining on-time of the PFC switch based additionally on a feedforward coefficient according to an embodiment of the disclosure. Other sequences of steps may also be performed according to alternative embodiments. For example, alternative embodiments of the disclosure may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

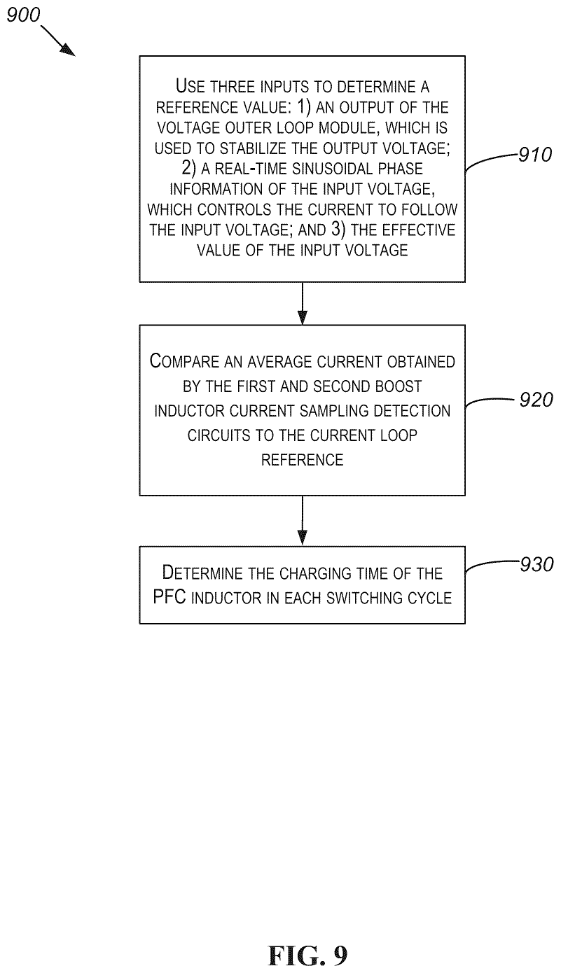

FIG. 9 illustrates a flowchart of an exemplary method 900 for determining the charging time of the PFC inductor in each switching cycle, according to some embodiments of the disclosure. At block 910, three inputs can be used to determine a reference value: 1) an output of the voltage outer loop module, which is used to stabilize the output voltage; 2) a real-time sinusoidal phase information of the input voltage, which controls the current to follow the input voltage; and 3) the effective value of the input voltage. At block 920, an average current obtained by the first and second boost inductor current sampling detection circuits can be compared to the current loop reference. At block 930, the charging time of the PFC inductor in each switching cycle can be determined.

It should be appreciated that the specific steps illustrated in FIG. 9 provide a particular method of determining the charging time of the PFC inductor in each switching cycle according to an embodiment of the disclosure. Other sequences of steps may also be performed according to alternative embodiments. For example, alternative embodiments of the disclosure may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, combination of the circuits and methods disclosed herein can be utilized to for digital control of totem pole PFC circuits operating in critical conduction mode (CrM). Although circuits and methods are described and illustrated herein with respect to several particular configuration of a CrM totem pole PFC circuit, embodiments of the disclosure are suitable for control methods of PFC circuits operating in other operating modes, such as, but not limited to, continuous conduction mode (CCM) and discontinuous conduction mode (DCM). Further, embodiments of the disclosure are suitable for control methods of single phase, two-phase, or multi-phase PFC circuits operating in CrM mode. Moreover, embodiments of the disclosure are suitable for use with other configurations of power converters. Other power converters can utilize circuits and techniques disclosed herein, for example, power converters such as, but not limited to, AC-DC power converters, AC-AC power converters, boost power converters, flyback converters, ACF, AHB, and LLC converters.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

One of ordinary skill in the art will appreciate that other modifications to the apparatuses and methods of the present disclosure may be made for implementing various applications of the methods and systems for enhanced area getter architecture for a wafer-level vacuum packaged uncooled focal plane array without departing from the scope of the present disclosure.

The examples and embodiments described herein are for illustrative purposes only. Various modifications or changes in light thereof will be apparent to persons skilled in the art. These are to be included within the spirit and purview of this application, and the scope of the appended claims which follow.

What is claimed is:

1. A power factor correction (PFC) circuit, comprising:
a first switch coupled to a second switch at a switch node;
an inductor coupled between the switch node and an AC input terminal; and
a control circuit arranged to:
detect an input voltage at the AC input terminal;
detect a current in the inductor and generate a signal corresponding to an average of the current;
detect an output voltage of the PFC circuit at an output terminal;
generate a reference current based on the detected output voltage and the detected input voltage; and
control a first on-time of the first switch and a second on-time of the second switch based on a comparison of the signal to the reference current.

2. The PFC circuit of claim 1, wherein the PFC circuit is arranged to operate in critical conduction mode (CrM).

3. The PFC circuit of claim 1, wherein the control circuit is further arranged to generate a feedforward coefficient based on the reference current and the input voltage.

4. The PFC circuit of claim 3, wherein the control circuit is further arranged to control the first on-time of the first switch and the second on-time of the second switch based additionally on the feedforward coefficient.

5. The PFC circuit of claim 1, wherein the control circuit is further arranged to generate a first off-time of the first switch when the current in the inductor reaches zero or negative.

6. The PFC circuit of claim 1, wherein the switch node is a first switch node, the inductor is a first inductor, and the first inductor is coupled between the first switch node and the AC input terminal, and wherein the PFC circuit further comprises a third switch coupled to a fourth switch at a second switch node, a second inductor coupled between the second switch node and the AC input terminal.

7. The PFC circuit of claim 6, wherein the combination of the first switch, the second switch, and the first inductor, and the combination of the third switch, the fourth switch, and the second inductor are arranged to operate in an interleaved mode with a phase delay of 180°.

8. The PFC circuit of claim 1, wherein the first switch and the second switch are gallium nitride (GaN) switches.

9. The PFC circuit of claim 1, wherein the first switch and the second switch are isolated gate bipolar transistor (IGBT) switches, or silicon switches, or silicon carbide (SiC) switches.

10. The PFC circuit of claim 6, wherein the control circuit is further arranged to generate a second off-time of the second switch when the current in the second inductor reaches zero.

11. A method of operating a power factor correction (PFC) circuit, the method comprising:
providing a first switch coupled to a second switch at a switch node;
providing an inductor coupled between the switch node and an AC input terminal;
detecting an input voltage at the AC input terminal;
detecting a current in the inductor and generate a signal corresponding to an average of the current;
detecting an output voltage of the PFC circuit at an output terminal;
generating a reference current based on the detected output voltage and the detected input voltage; and
controlling a first on-time of the first switch and a second on-time of the second switch based on a comparison of the signal to the reference current.

12. The method of claim 11, wherein the PFC circuit is a totem pole PFC circuit.

13. The method of claim 11, wherein the PFC circuit is arranged to operate in critical conduction mode (CrM).

14. The method of claim 11, further comprising generating a feedforward coefficient based on the reference current and the input voltage.

15. The method of claim 14, further comprising controlling the first on-time of the first switch and the second on-time of the second switch based additionally on the feedforward coefficient.

16. The method of claim 11, further comprising generating a first off-time of the first switch when the current in the inductor reaches zero.

17. The method of claim 11, wherein the switch node is a first switch node, the inductor is a first inductor, and the first inductor is coupled between the first switch node and the AC input terminal, and wherein the method further comprises providing a third switch coupled to a fourth switch at a second switch node, and providing a second inductor coupled between the second switch node and the AC input terminal.

18. The method of claim 17, wherein the combination of the first switch, the second switch, and the first inductor, and the combination of the third switch, the fourth switch, and the second inductor are arranged to operate in an interleaved mode with a phase delay of 180°.

19. The method of claim 18, further comprising generating a second off-time of the second switch when the current in the second inductor reaches zero.

20. A method of operating a multi-phase critical conduction mode totem pole power factor correction (PFC) circuit, the method comprising:
providing a first phase having a first switch coupled to a second switch at a first switch node;
providing a second phase having a third switch coupled to a fourth switch at a second switch node;
providing a first inductor coupled between the first switch node and an AC input terminal;
providing a second inductor coupled between the second switch node and the AC input terminal;
detecting a current in the first inductor and generating a signal corresponding to an average of the current;
detecting a first switching period of the first phase and a second switching period of second phase;
detecting a phase error between the first switching period and the second switching period;
generating a reference current based on a sampled value of the phase error and a reference value of phase error; and
controlling an on-time of third and fourth switches based at least on a comparison of the signal to the reference current.
